(19) United States
(12) Patent Application Publication
(10) Pub. No.: US 2021/0164938 A1
(43) Pub. Date: Jun. 3, 2021

(54) Method for forming a smooth peripheral surface of a bottom side of an assembled electrophoresis gel cassette with no surface discontinuities

(71) Applicant: SMOBiO Technology, Inc., Hsinchu City (TW)

(72) Inventor: KUAN-LIN LEE, Hsinchu City (TW)

(73) Assignee: SMOBiO Technology, Inc., Hsinchu City (TW)

(21) Appl. No.: 16/699,141

(22) Filed: Nov. 29, 2019

(51) Int. Cl. G01N 27/447

(52) U.S. Cl. CPC G01N 27/44717; G01N 27/44743; G01N 27/44756

(57) ABSTRACT

A method for forming a smooth peripheral surface of a bottom side of an assembled electrophoresis gel cassette with no surface discontinuities is disclosed, including a cutting step for cutting off an overlapping part of a bottom portion of the assembled electrophoresis gel cassette.

### FIELD OF THE INVENTION

The present invention relates to a method for manufacturing an electrophoresis gel cassette, in particular, to a method of forming a smooth peripheral surface of a bottom side of an assembled electrophoresis gel cassette with no surface discontinuities.

### BACKGROUND OF THE INVENTION

Electrophoresis is a commonly used method for identifying and isolating biological macromolecules in the field of molecular biology. The principle is to utilize the differences in the speed these molecules will travel within a medium under the influence of an electric field because of a difference in molecular weight and charge value between different biomacromolecules. The result of this process is a separation and isolation of biological macromolecules.

The medium commonly used in electrophoresis to separate biomacromolecules is an electrophoretic gel, which is generally flat and has regularly-spaced wells to hold the macromolecules to be tested. In general, electrophoretic gels are divided into two major types: agarose gels and polyacrylamide gels. Agarose gels are relatively easy to manufacture and their main ingredients are derived from polysaccharide polymers in seaweed. Although the pore sizes of agarose gels are less uniform, the separation effect on the DNA fragment and proteins larger than 200 kDa is better. Polyacrylamide gels have relatively smaller and more uniform pore sizes compared to agarose gels and are therefore commonly used to separate proteins. In addition, polyacrylamide gels generally have better resolution and are therefore more expensive than agarose gels. However, it should be noted that polyacrylamide gel powder is toxic and should be used with care.

In the past, most laboratories used their own electrophoresis gels. However, the benefits of using precast electrophoretic gel were quickly discovered: they saved time and were easier to produce accurate, consistent results. The manufacture of precast electrophoretic gel is to assemble the electrophoresis gel cassette and to seal the bottom of the electrophoresis gel cassette with a tape to prevent from a leakage of the liquid matrix of gel during preparation of electrophoresis gel. However, the most important problem to be solved is that if the bottom of the electrophoresis gel cassette cannot form a continuous planar surface, even if a tape is used to seal the bottom of the electrophoresis gel cassette, the liquid matrix of gel is still leaked.

At present, some methods for preparing electrophoretic gel cassette have been used to prevent from a leakage of the liquid matrix of gel. For example, Bio-Rad creates an integrally formed pane structure at the bottom of the electrophoretic gel cassette to prevent from the irregularity of the bottom of the electrophoretic gel cassette during assembling; for another example, there is also a design in which an electrophoresis gel cassette is assembled and the bottom is rolled to be flat by a hot roller, but the risk of this design is an increase in cost and lack of the production quality. Hence, a further improved method is required to form a smooth peripheral surface of a bottom side of the assembled electrophoresis gel cassette with no surface discontinuities is provided to effectively improve the product quality and reduce the cost.

### SUMMARY OF THE INVENTION

The invention provides a method for forming a smooth peripheral surface of a bottom side of an assembled electrophoresis gel cassette with no surface discontinuities, comprising a cutting step for cutting off an overlapping part of a bottom portion of the assembled electrophoresis gel cassette.

The method according to the invention, wherein the assembled electrophoresis gel cassette comprises a first plate, a second plate, and a plurality of spacers, wherein the first plate and the second plate respectively comprises a top side, a bottom side, a left side, a right side, a first surface and a second surface, the second plate is substantially parallel to the first plate so that the first surface of the first plate and the first surface of the second plate are parallel to each other, and the plurality of spacers are disposed on a left portion and a right portion of the first surface of the first plate or the second plate, and the first plate, the second plate, and the plurality of spacers are assembled together to form a gel accommodating space.

A step is further provided of providing a sealing element for sealing the smooth peripheral surface of the bottom sides of the electrophoresis gel cassette to prevent from a leakage of a liquid matrix of gel.

### BRIEF DESCRIPTION OF THE DRAWINGS

FIG. 1 shows the performing processes according the invention, 1A is to provide an electrophoresis gel cassette; 1B is the bonding step; and 1C is the cutting step.

FIG. 2 shows the smooth peripheral surface of a bottom side of the assembled electrophoresis gel cassette with no surface discontinuities is obtained via a cutting step, and the sealing element is further provided to seal the smooth peripheral surface of a bottom side of the assembled electrophoresis gel cassette with no surface discontinuities to prevent from a leakage of the liquid matrix of gel during preparation of electrophoresis gel.

FIG. 3 shows one embodiment that the electrophoresis gel cassette according to the invention comprises at least one bottom protrusion.

FIG. 4 shows one embodiment that the electrophoresis gel cassette according to the invention comprises at least one top protrusion.

### DETAILED DESCRIPTION OF THE INVENTION

A method for forming a smooth peripheral surface of a bottom side of an assembled electrophoresis gel cassette with no surface discontinuities, comprising a cutting step for cutting off an overlapping part of a bottom portion of the assembled electrophoresis gel cassette.

The assembled electrophoresis gel cassette according to the invention comprises a first plate, a second plate, and a plurality of spacers, wherein the first plate and the second plate respectively comprises a top side, a bottom side, a left side, a right side, a first surface and a second surface, the second plate is substantially parallel to the first plate so that the first surface of the first plate and the first surface of the second plate are parallel to each other, and the plurality of spacers are disposed on a left portion and a right portion of the first surface of the first plate or the second plate, and the first plate, the second plate, and the plurality of spacers are assembled together to form a gel accommodating space.

Preferably, the first plate, the second plate, and the plurality of spacers are assembled after aligning the second plate substantially parallel to the first plate; most preferred, the first plate, the second plate, and the plurality of spacers are assembled by bonding the first plate, the second plate, and the plurality of spacers.

The method according to the invention further comprises a step of providing a sealing element for sealing the smooth peripheral surface of a bottom side of the assembled electrophoresis gel cassette with no surface discontinuities, and the sealing element is tape, clay, glue, hydrogel, or vaseline.

The overlapping part of the bottom portion of the electrophoresis gel cassette according to the invention is cut off by a diamond knife, a laser knife, a water jet, a saw, a high-speed saw blade, a planer, or a high-speed planer.

The said term “integrally formed” herein indicates “an object is formed by assembling two parts into one piece” or “an object is formed in one-piece during manufacture”.

In an embodiment, the said plurality of spacers are disposed on the left portion and the right portion of the first surfaces of the first plate and the second plate; preferably, the plurality of spacers are integrally formed with the first plate or the second plate.

In a preferred embodiment, the first plate, the second plate, and the plurality of spacers are bonded by using an adhesive or ultrasonic oscillation.

The electrophoresis gel cassette according to the invention is further provided to comprise at least one protrusion which is disposed at an appropriate position on a bottom portion of the first surface of the first plate or the second plate for connecting the first plate and the second plate so as to maintain the electrophoresis gel accommodating space, the at least one protrusion may be also provided to be disposed at an appropriate position on a top portion of the first surface of the first plate or the second plate.

Preferably, the at least one protrusion is integrally formed with the first plate or the second plate.

Before the cutting step is performed, in one preferred embodiment, the at least one protrusion is first bonded to the first plate or the second plate.

### DESCRIPTION OF EMBODIMENTS

The examples below are non-limiting and are merely representative of various aspects and features of the present invention.

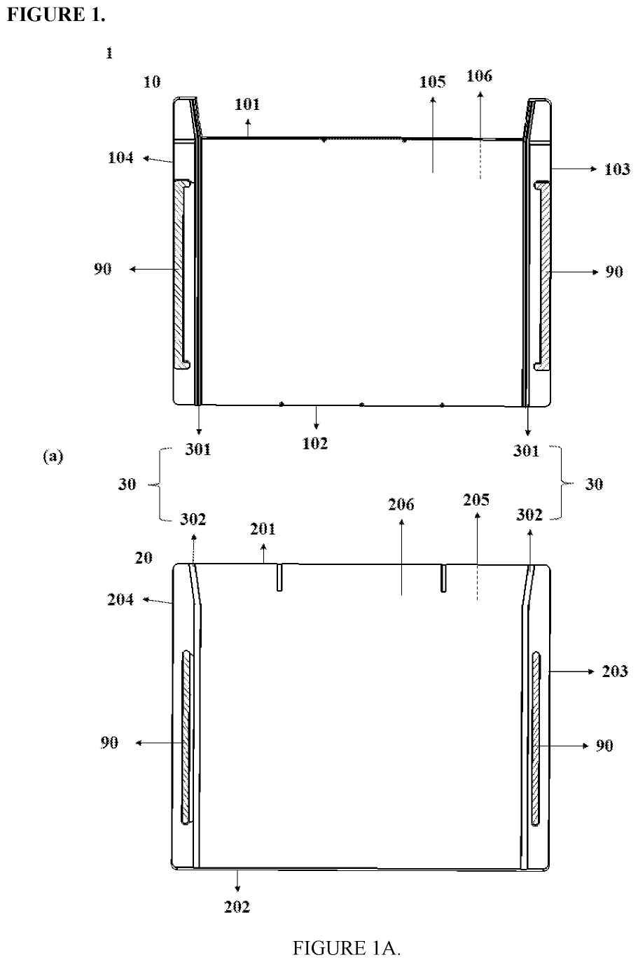

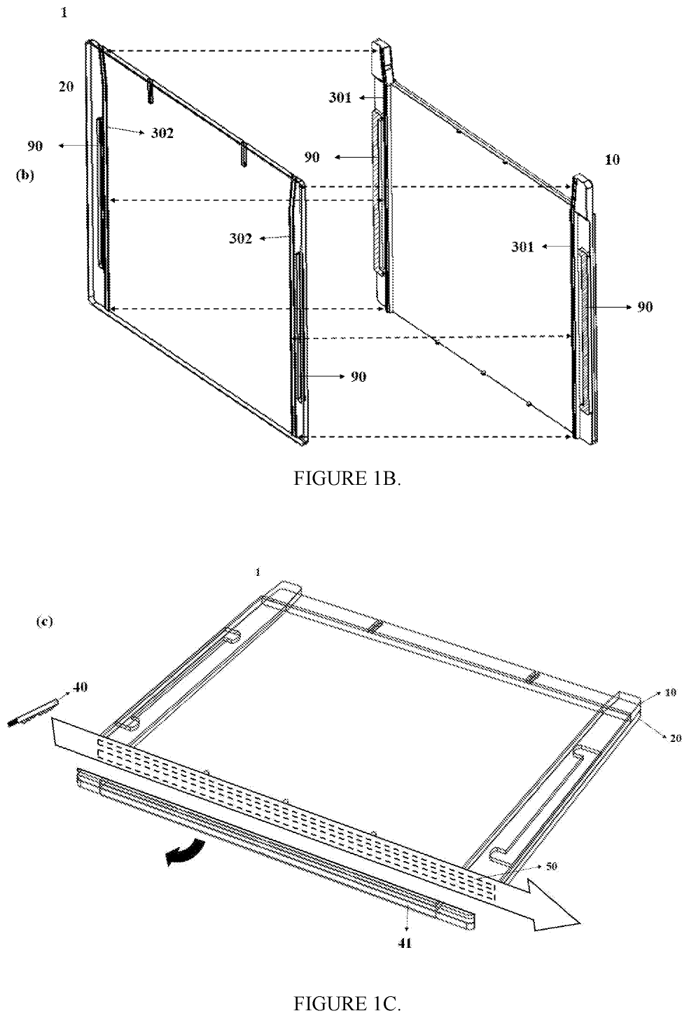

The invention recites a method for forming a smooth peripheral surface of a bottom side of an assembled electrophoresis gel cassette with no surface discontinuities, for example, to manufacture a novel electrophoresis gel cassette to prevent from a leakage of the liquid matrix of gel happening during the preparation of electrophoresis gel, in which the method is provided to effectively improve the product quality and reduce the cost by a simple cutting step. In detail, it is important that a cutting step is performed to form a smooth peripheral surface of a bottom side of the assembled electrophoresis gel cassette with no surface discontinuities. As shown in FIG. 1, the invention provided a method comprised the following steps: (a) providing an electrophoresis gel cassette 1 which comprised a first plate 10, a second plate 20, and a plurality of spacers 30, wherein the first plate 10 comprised a top side 101, a bottom side 102, a right side 103, a left side 104, a first surface 105, and a second surface 106; also, the second plate 20 comprised a top side 201, a bottom side 202, a right side 203, a left side 204, a second surface 205, and a first surface 206, the second plate 20 is substantially parallel to the first plate 10 so that the first surface 105 of the first plate 10 and the first surface 206 of the second plate 20 are parallel to each other, and the plurality of spacers 30 are disposed on a left portion and a right portion of the first surface 105 of the first plate 10 or the second plate 20, wherein the plurality of spacer elements 30 meant convex edges 301 respectively disposed on the left portion and the right portion of the inner side surface 105 of the first plate 10 and concave edges 302 respectively disposed on the left portion and the right portion of the inner side surface 206 of the second plate 20; (b) a bonding step for bonding the first plate 10, the second plate 20, and the plurality of spacers 30 together to form a gel accommodating space; and (c) a cutting step for cutting off an overlapping part 41 of bottom portions of the first plate 10 and the second plate 20 by using a cutting tool 40 to form a smooth peripheral surface of a bottom side of the assembled electrophoresis gel cassette with no surface discontinuities.

The plurality of spacers of the electrophoresis gel cassette may be disposed on a left portion and a right portion of the first surface of the first plate and/or the second plate. Preferably, the plurality of spacers may be integrally formed with the first plate and/or the second plate. In the embodiment according to the invention as shown in FIG. 1, the convex edges 301 was respectively and integrally formed on the left portion and the right portion of the first surface 105 of the first plate 10 and concave edges 302 was respectively and integrally formed on the left portion and the right portion of the first surface 206 of the second plate 20.

In one embodiment, as shown in FIG. 1, the bonding step was performed after aligning the top sides, the bottom sides, the left sides, and the right sides of the first plate 10 and the second plate 20 through at least one positioning element 90 disposed beside the plurality of spacers 30 on the left portion and the right portion of the first surfaces of the first plate 10 and the second plate 20.

In one preferred embodiment, the bonding step (b) was performed by using an adhesive or an ultrasonic oscillation.

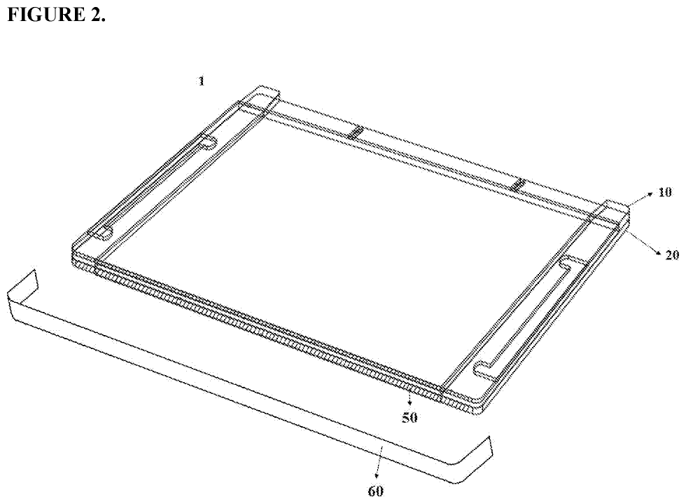

After the cutting step (c) as shown in FIG. 1, see FIG. 2, the sealing step was further provided for sealing the smooth peripheral surface of a bottom side of the assembled electrophoresis gel cassette with no surface discontinuities 50 by a sealing element 60 to prevent from a leakage of the liquid matrix of gel during the preparation of electrophoresis gel.

Preferably, the sealing element was tape, clay, glue, hydrogel, or Vaseline, in this embodiment, tape was used.

The invention further comprises at least one bottom protrusion which was disposed at an appropriate position on a bottom portion or on a top portion of the first surface of the first plate 10 or the second plate 20 for connecting the first plate 10 and the second plate 20 so as to maintain the electrophoresis gel accommodating space.

In one preferred embodiment, the at least one bottom/top protrusion was a plurality of bottom protrusions/top protrusions; in a most preferred embodiment, the plurality of bottom/top protrusions were equidistantly disposed from each other at an appropriate position on the bottom/top portion of the first surface of the first plate 10 or the second plate 20.

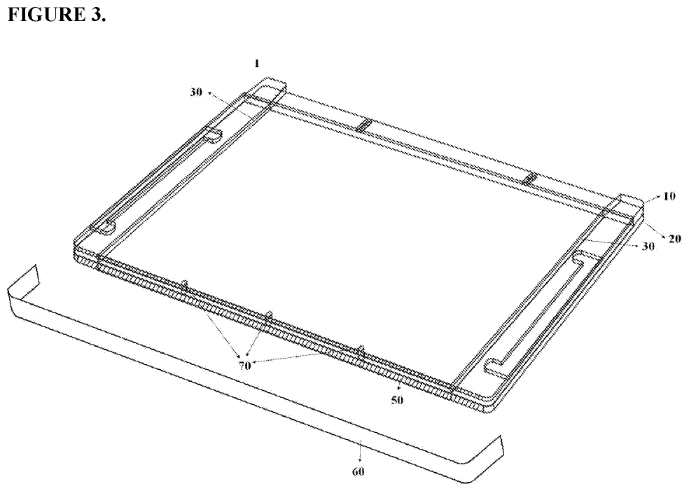

In one preferred embodiment, the first plate, the second plate, the plurality of spacers and the at least one protrusion were bonded together by using an ultrasonic oscillation to ensure that the structure of the electrophoresis gel cassette was stably fixed and was further maintained during the cutting step, hence, the smooth peripheral surface of a bottom side of the assembled electrophoresis gel cassette with no surface discontinuities was formed. As shown in FIG. 3, the electrophoresis gel cassette of the invention further comprised a plurality of bottom protrusions 70. After the first plate 10, the second plate 20, the plurality of spacers 30 and the plurality of bottom protrusions 70 were stably bonded together by using an ultrasonic oscillation, the smooth peripheral surface of a bottom side of the assembled electrophoresis gel cassette with no surface discontinuities 50 was formed by cutting off the overlapping part of a bottom portion of the assembled electrophoresis gel cassette 1, and the sealing element 60 was followingly provided for the sealing step.

The appropriate position of the said plurality of bottom protrusions 70 was a position at which an electrophoresis sample did not flow through during an electrophoresis processing.

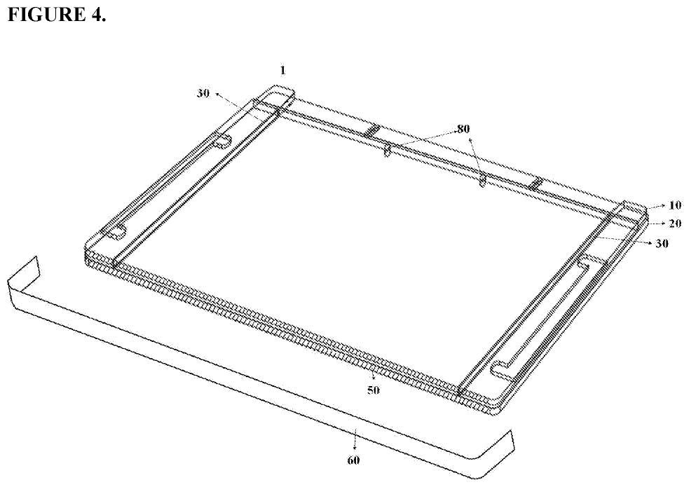

As shown in FIG. 4, the electrophoresis gel cassette of the invention further comprises a plurality of top protrusions 80. After the first plate 10, the second plate 20, the plurality of spacers 30 and the plurality of top protrusions 80 were stably bonded together by using an ultrasonic oscillation, the smooth peripheral surface of a bottom side of the assembled electrophoresis gel cassette with no surface discontinuities 50 was formed by cutting off the overlapping part of bottom portion of the assembled electrophoresis gel cassette 1, and the sealing element 60 was followingly provided for the sealing step.

The appropriate position of the said plurality of top protrusions 80 was a position at which an electrophoresis sample did not flow through during an electrophoresis processing.

The appropriate cutting method and tool of the cutting step according to the invention is selected and performed by considering the material of the first plate and the second plate. If the first plate and the second plate are made from plastic, such as Polyvinyl Chloride (PVC), Acrylic, Polylactic Acid (PLA), Polystyrene (PS), Polypropylene (PP), Styrene-acrylonitrile copolymer (AS), Acrylonitrile Butadiene Styrene (ABS), Polycarbonate (PC), Polyethylene terephthalate (PET), or Polyethylene (PE), the appropriate cutting tool to be used for the cutting step is a diamond knife, a laser knife, a water jet, a saw, a high-speed saw blade, a planer, or a high-speed planer; if the first plate and the second plate are made from glass, then the appropriate cutting tool to be used for the cutting step is a diamond knife, a water jet, a saw, a high-speed saw blade, a planer, or a high-speed planer.

While the invention has been described and exemplified in sufficient detail for those skilled in this art to make and use it, various alternatives, modifications, and improvements should be apparent without departing from the spirit and scope of the invention.

One skilled in the art readily appreciates that the present invention is well adapted to carry out the objects and obtain the ends and advantages mentioned, as well as those inherent therein. The embodiments are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

What is claimed is:

1. A method for forming a smooth peripheral surface of a bottom side of an assembled electrophoresis gel cassette with no surface discontinuities, comprising a cutting step for cutting off an overlapping part of a bottom portion of the assembled electrophoresis gel cassette.

2. The method according to claim 1, wherein the assembled electrophoresis gel cassette comprises a first plate, a second plate, and a plurality of spacers, wherein the first plate and the second plate respectively comprises a top side, a bottom side, a left side, a right side, a first surface and a second surface, the second plate is substantially parallel to the first plate so that the first surface of the first plate and the first surface of the second plate are parallel to each other, and the plurality of spacers are disposed on a left portion and a right portion of the first surface of the first plate or the second plate, and the first plate, the second plate, and the plurality of spacers are assembled together to form a gel accommodating space.

3. The method according to claim 2, wherein the first plate, the second plate, and the plurality of spacers are assembled by bonding the first plate, the second plate, and the plurality of spacers.

4. The method according to claim 1 further comprises a step of providing a sealing element for sealing the smooth peripheral surface of the bottom sides of the electrophoresis gel cassette to prevent from a leakage of a liquid matrix of gel.

5. The method according to claim 4, wherein the sealing element is a tape, clay, a glue, a hydrogel, or vaseline.

6. The method according to claim 1, wherein the overlapping part of the bottom portion of the electrophoresis gel cassette is cut off by a diamond knife, a laser knife, a water jet, a saw, a high-speed saw blade, a planer, or a high-speed planer.

7. The method according to claim 2, wherein the first plate, the second plate, and the plurality of spacers are assembled after aligning the second plate substantially parallel to the first plate.

8. The method according to claim 2, wherein the plurality of spacers are disposed on a left portion and a right portion of the first surfaces of the first plate and the second plate.

9. The method according to claim 2, wherein the plurality of spacers are integrally formed with the first plate or the second plate.

10. The method according to claim 3, wherein the first plate, the second plate, and the plurality of spacers are bonded by using an adhesive or ultrasonic oscillation.

11. The method according to claim 2, wherein the electrophoresis gel cassette further comprises at least one protrusion which is disposed at an appropriate position on a bottom portion of the first surface of the first plate or the second plate for connecting the first plate and the second plate so as to maintain the electrophoresis gel accommodating space.

12. The method according to claim 2, wherein the electrophoresis gel cassette further comprises at least one protrusion which is disposed at an appropriate position on a top portion of the first surface of the first plate or the second plate for connecting the first plate and the second plate so as to maintain the electrophoresis gel accommodating space.

13. The method according to claim 2, wherein the first plate and the second plate are made from plastic.

14. The method according to claim 13, wherein the plastic is selected from Polyvinyl Chloride (PVC), Acrylic, Polylactic Acid (PLA), Polystyrene (PS), Polypropylene (PP), Styrene-acrylonitrile copolymer (AS), Acrylonitrile Butadiene Styrene (ABS), Polycarbonate (PC), Polyethylene terephthalate (PET), or Polyethylene (PE).

15. The method according to claim 14, wherein the overlapping part of bottom portion of the electrophoresis gel cassette is cut off by a diamond knife, a laser knife, a water jet, a saw, a high-speed saw blade, a planer, or a high-speed planer.

16. The method according to claim 2, wherein the first plate and the second plate are made from glass.

17. The method according to claim 16, wherein the overlapping part of bottom portion of the electrophoresis gel cassette is cut off by a diamond knife, a water jet, a saw, a high-speed saw blade, a planer, or a high-speed planer.
